(19) United States
(12) Patent Application Publication
(10) Pub. No.: US 2026/0286706 A1
(43) Pub. Date: Sep. 24, 2026

(54) MODULAR INCLINED POSITIONABLE RAMP

(71) Applicant: Jon Webb, Draper, UT (US)

(72) Inventor: Jon Webb, Draper, UT (US)

(21) Appl. No.: 19/085,525

(22) Filed: Mar. 20, 2025

(51) Int. Cl. E04F 11/00; A01K 1/035

(52) U.S. Cl. CPC E04F 11/002; A01K 1/035; E04F 2011/005

(57) ABSTRACT

A rollable ramp overlayable and positionable upon stairs having a plurality of ramp modules comprising triangular sidewalls, each module hingedly or detachable affixed to one or more adjacent ramp modules.

### FIELD OF THE INVENTION

This invention relates to stairs and more particularly relates to modularized ramps positionable on stairs to permit use of the stairs as ramps.

### BACKGROUND

### Description of the Related Art

Most pets and ambulatory animals cannot climb or descend stairs but can do so on ramps or inclined platforms. The ability to ascend and descend the stairs and to reach elevated points in a home or other setting can be otherwise impossible for an animal if the animal is small, disabled, old, or wounded.

Because ramps and platforms are cumbersome and usually too heavy and elongated to temporarily install, ramps are simply omitted from most settings in which animals need them.

There is a need in the art for a modular, inclined positionable ramp for ambulatory animals and people which does not suffer from the deficiencies inherent in the prior art. It is therefore an object of the present invention to provide a modular positionable ramp for ambulatory animals and people.

### SUMMARY

From the foregoing discussion, it should be apparent that a need exists for a modular, inclined positionable ramp. Beneficially, such a device would overcome inefficiencies with the prior art by providing an effective means of porting, assembling and disassembling such ramps. The present invention has been developed in response to the present state of the art, and in particular, in response to the problems and needs in the art that have not yet been fully solved by currently available apparati. Accordingly, the present invention has been developed to provide a modular positionable ramp assemblage comprising: a modular positionable ramp assemblage comprising: a plurality of ramp modules, each ramp module comprising: a triangular body defining a hollow interior recess; an inclined top surface affixed to a top surface of the ramp module; wherein each ramp module is dimensioned to fit above, without cantileveing over, a standard-size stair of a staircase; wherein each of the plurality of ramp modules are hingedly affixed to one or more adjacent ramp modules such that the ramp assemblage is operable to roll into a closed configuration.

Each ramp module may further comprise two triangular sidewalls, a hypotenuse of each sidewall detachably affixed to an inclined top surface. The inclined top surface forms two or more stairs. Each ramp module further comprises one rectangular baseplate detachably affixed to the two triangular sidewalls. Each ramp module further may comprise two triangular sidewalls, a hypotenuse of each sidewall detachably affixed to an inclined top surface. The sidewalls may define a plurality of apertures adapted to align with the slots.

The modular positionable ramp assemblage may further comprise two stringers.

A second modular positionable ramp assemblage is provided comprising: a plurality of ramp modules comprising a solid block of polymeric material shaped to include: a single rectangular platform having a planar top surface; two triangular sidewalls, an hypotenuse of each sidewall detachably affixed to the rectangular platform; a rectangular baseplate affixed to the two triangular sidewalls; a rectangular backplate detachably affixed to the two triangular sidewalls; wherein each of the plurality of ramp modules are hingedly affixed to one or more adjacent ramp modules.

Each ramp module may further comprises a textured top surface. The inclined top surface forms two or more stairs.

A third modular positionable ramp assemblage is provided comprising: a plurality of ramp modules, each ramp module comprising: a triangular body defining a hollow interior recess; wherein each ramp module is dimensioned to fit above, without cantileveing over, a standard-size stair of a staircase; a flexible, inclined top surface affixed across top surfaces of the ramp modules, the flexible inclined top surface bending at connection points between the ramp modules such that the ramp assemblage is operable to roll into a closed configuration.

Each ramp module further comprises two triangular sidewalls, a hypotenuse of each sidewall detachably affixed to an inclined top surface. The inclined top surface may form two or more stairs.

Each ramp module may further comprise one rectangular baseplate detachably affixed to the two triangular sidewalls. Each ramp module may further comprise two triangular sidewalls, a hypotenuse of each sidewall detachably affixed to an inclined top surface.

The sidewalls may define a plurality of apertures adapted to align with the slots. The modular positionable ramp assemblage further comprises, in some embodiments, two stringers.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric perspective view of a modular, inclined positionable ramp for ambulatory animals in accordance with the present invention;

FIG. 2A is an isometric perspective view of a modular, inclined positionable ramp for ambulatory animals in accordance with the present invention;

FIG. 2B is an isometric perspective view of a modular, inclined positionable ramp for ambulatory animals in accordance with the present invention;

FIG. 3 is an exploded perspective view of a modular, inclined positionable ramp for ambulatory animals in accordance with the present invention;

FIG. 4 is a disassemmbled perspective view of a modular, inclined positionable ramp for ambulatory animals in accordance with the present invention;

FIG. 5 is an exploded perspective view of a modular, inclined positionable ramp for ambulatory animals in accordance with the present invention;

FIG. 6 is an exploded perspective view of a modular, inclined positionable ramp for ambulatory animals in accordance with the present invention;

FIG. 7 is an environmental perspective view of a modular, inclined positionable ramp for ambulatory animals in accordance with the present invention;

FIG. 8 is a perspective view of an annular snap fit of a modular, inclined positionable ramp for ambulatory animals in accordance with the present invention;

FIG. 9 is an exploded perspective view of a modular, inclined positionable ramp for ambulatory animals in accordance with the present invention;

FIG. 10 is an environmental perspective view of a modular, inclined positionable ramp for ambulatory animals in accordance with the present invention;

FIG. 11 is an environmental perspective view of a modular, inclined positionable ramp for ambulatory animals in accordance with the present invention;

FIG. 12 is an environmental perspective view of a ramp module of a modular, inclined positionable ramp for ambulatory animals in accordance with the present invention;

FIG. 13 is a top perspective view of a rolled, positionable ramp for ambulatory animals in accordance with the present invention;

FIG. 14 is a top perspective view of a rolled, positionable ramp for ambulatory animals in accordance with the present invention;

FIG. 15 is a side, environmental perspective view of a rolled, positionable ramp for ambulatory animals in accordance with the present invention;

FIG. 16 is a perspective view of a rollable ramp for ambulatory animals in accordance with the present invention; and

FIG. 17 is a perspective view of a positionable ramp module for ambulatory animals in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

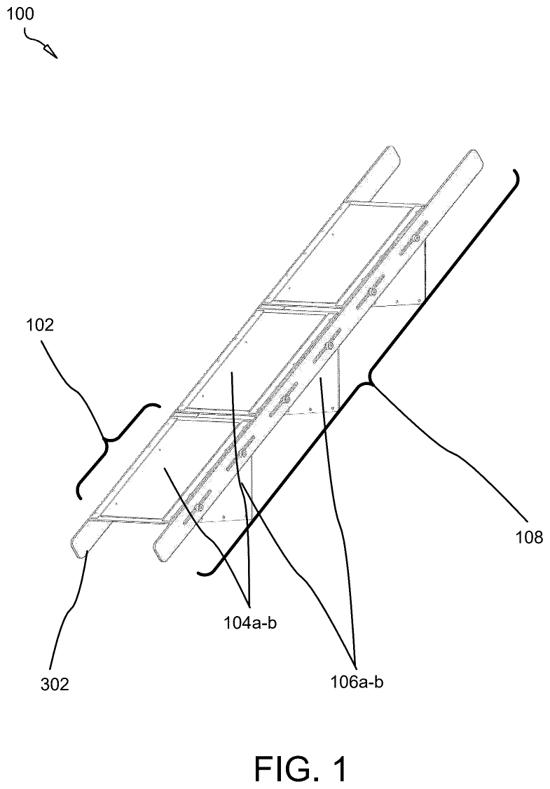

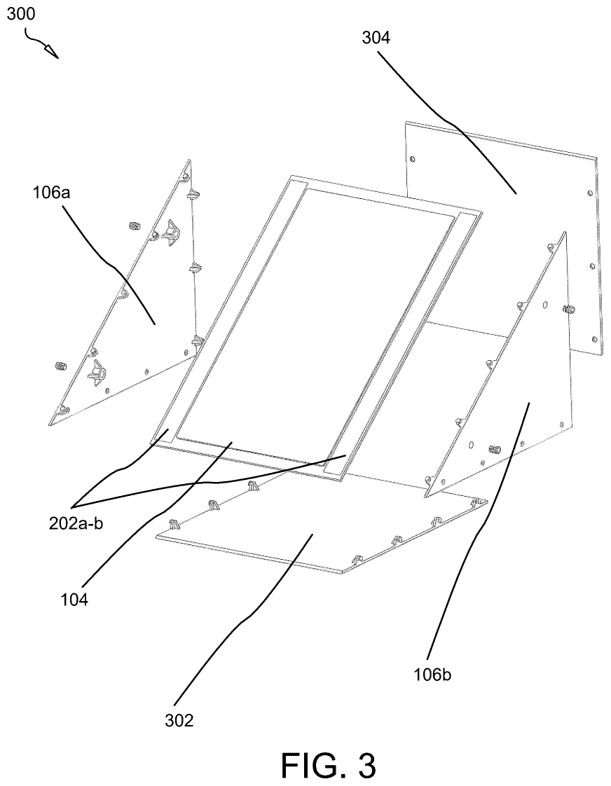

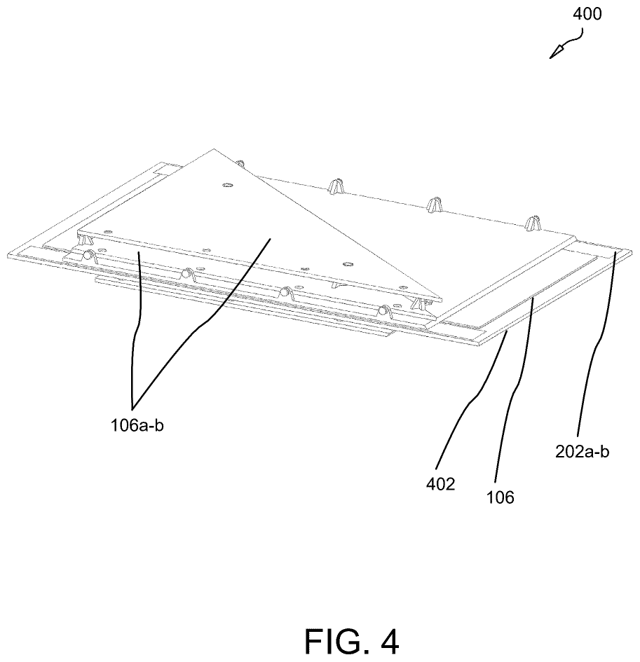

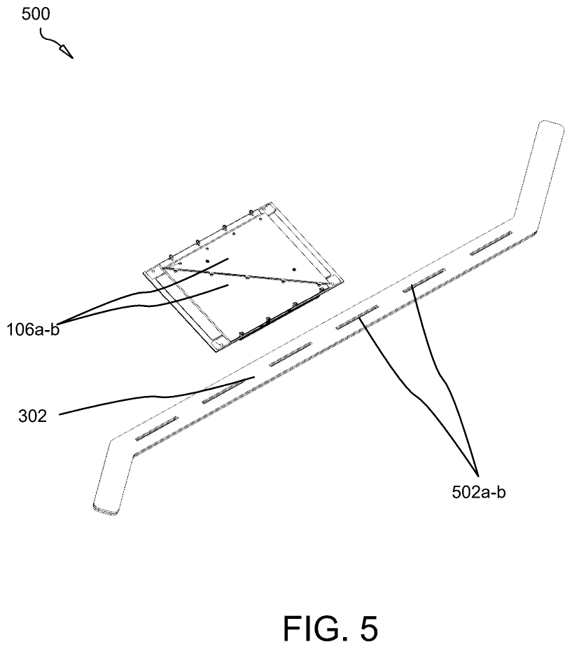

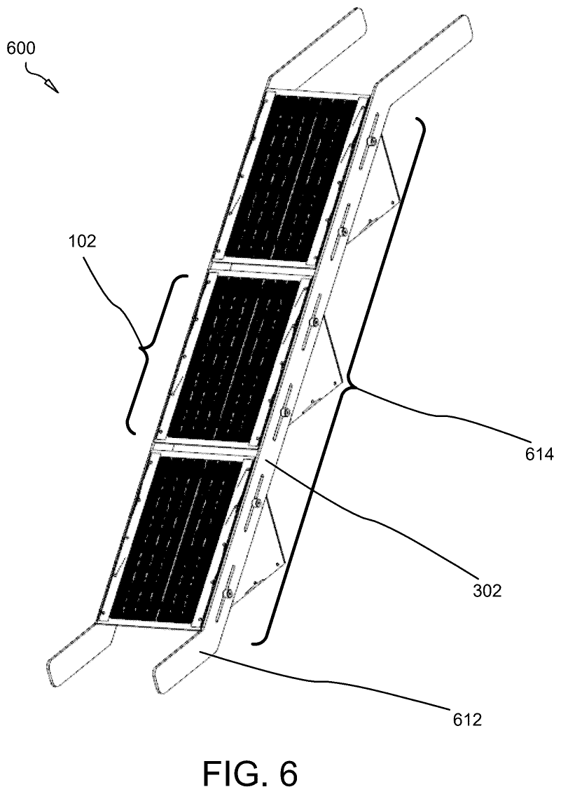

FIG. 1-6 illustrate various perspective views of a modular, inclined positionable ramp for ambulatory animals in accordance with the present invention.

The ramp 100 may comprise two stringers 302, each stringer 302 defining a plurality of slots 502. The slots 502 are positioned running in parallel with one another. The slots 502 may be positioned within the length of a mid-section 614 of the stringer 302, said slots 502 traversing the stringers 302 centrally and spaced a regular intervals across a length of the mid-section 614 and/the stringer 302.

In various embodiments, the stringers 302 define jutting, or cantilevering, terminal ends 612 affixed and angled at between 90 degrees and 179 degrees from the mid-section of the stringer 302. The terminal ends 612 may be hingedly connected or connectable to the mid-section 614.

The ramp 100 comprises a plurality of ramp modules 102, each ramp module having an inclined platform 104 and two triangular sidewalls 106 whose hypotenuse is detachably affixed to a lower surface of the platform 104. The sidewalls 106 detachably affix to the stringers 302.

The modules 102 may comprise a baseplate 302 and/or a backplate 304.

A plurality of modules may be combined and affixed to the stringers to form the ramp 100.

In various embodiments, the components of the ramp 100, 400 are detached and laid horizontally one upon another as shown for packing, shipping and stowing efficiency.

In some embodiments, the stringers 302 are omitted from the ramp 200. Instead, the assembly 200 comprises only a plurality of modules 102 which are stacked on stairs and not independently connected with stringers 302. In these embodiments, the module 102 may be formed a rigid or semi-rigid polymeric material such as Styrofoam, fiberglass or any other polymeric material. The modules 102 may also comprise or consist of organic materials such as wood, leather or cardboard.

The modules 102 may form a hollow interior recess or may be of dense design without a hollow interior recess. In some embodiments, a top surface 254 of the module 102 may have an overlaid or inlaid texture 252 operable to provide traction to an animal and/or pet. The texture may be adhered to the module 102 or formed therewith as a single integrated piece.

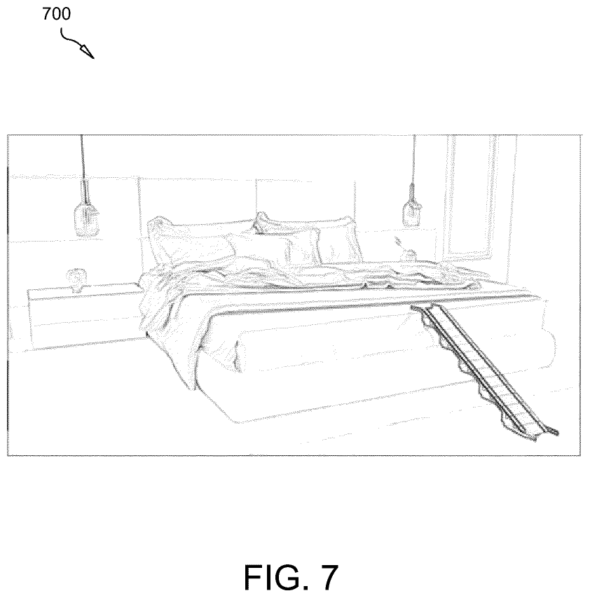

FIG. 7 is an environmental perspective view of a modular, inclined positionable ramp for ambulatory animals in accordance with the present invention.

As shown, in various embodiments, the ramp 700 may position alongside a bed and allow animals access to the same. The dimensions of the ramp 700 may vary from one embodiment to another.

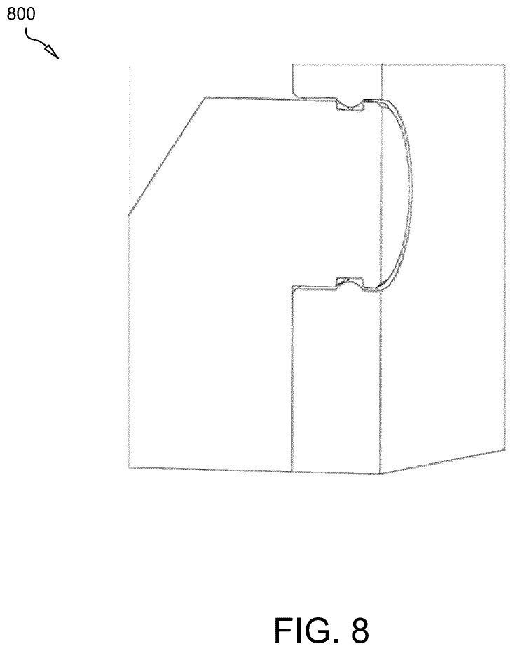

FIG. 8 is a perspective view of an annular snap 800 fit of a modular, inclined positionable ramp for ambulatory animals in accordance with the present invention.

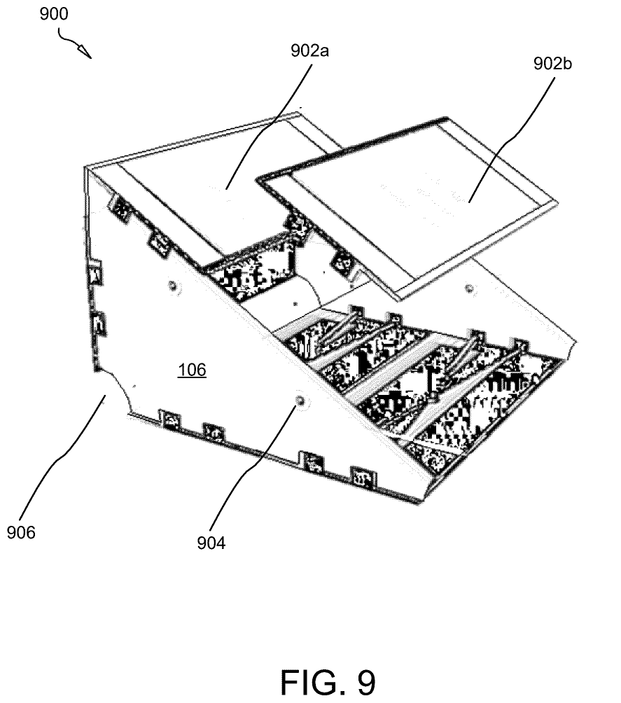

FIG. 9 is an exploded perspective view of a modular, inclined positionable ramp 900 for ambulatory animals in accordance with the present invention.

In some embodiments, textured top plates 902a-b may position upon the triangular sidewalls 106 and affix thereto with screws or bolts and threaded apertures 904. The triangular sidewalls 106 may be notched or define a recess 906 where the catheti conjoin.

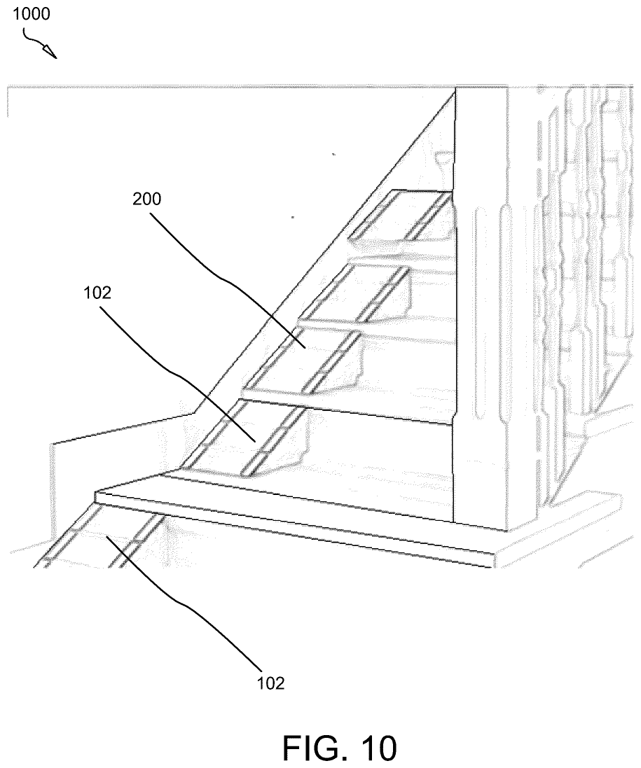

FIG. 10 is an environmental perspective view of a modular, inclined positionable ramp 1000 for ambulatory animals in accordance with the present invention.

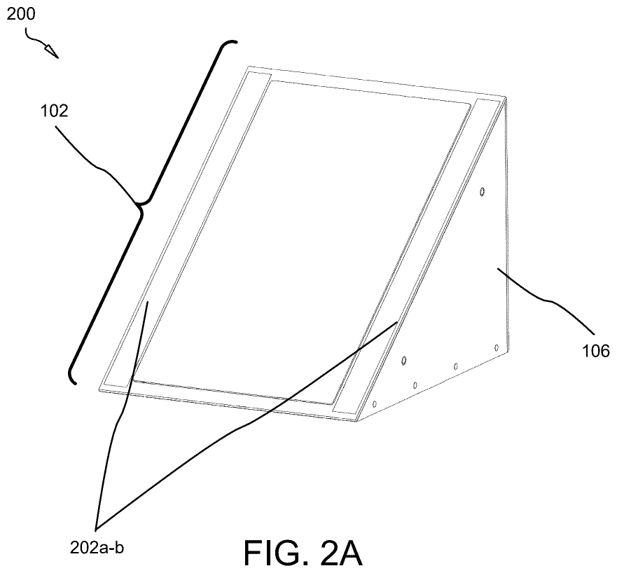

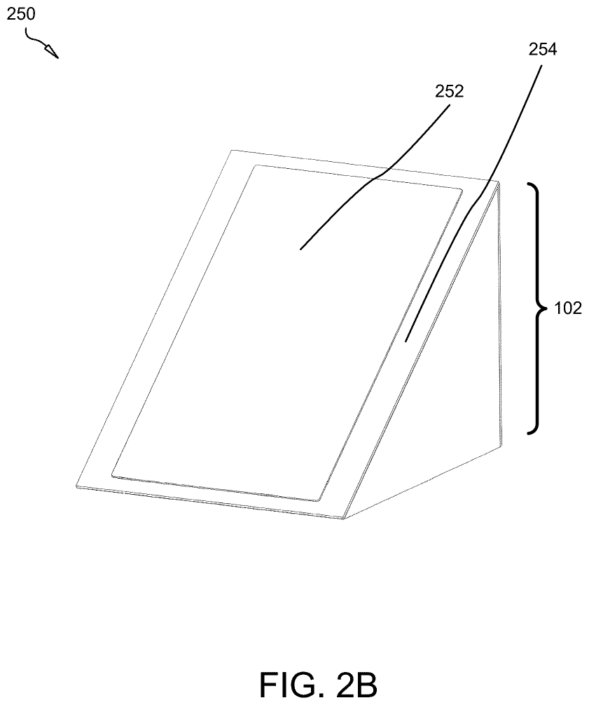

In some embodiments of the present invention, the modules 102 may be positioned upon stairs without the stringers 302. The ramp 1000 may include modules 102 which are solid embodiments such as shown in FIG. 2B or the other embodiments shown.

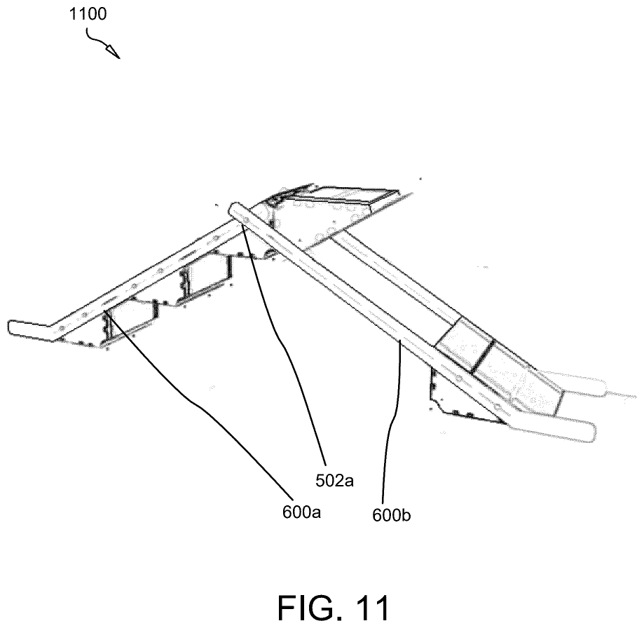

FIG. 11 is an environmental perspective view of a modular, inclined positionable ramp 1100 for ambulatory animals in accordance with the present invention.

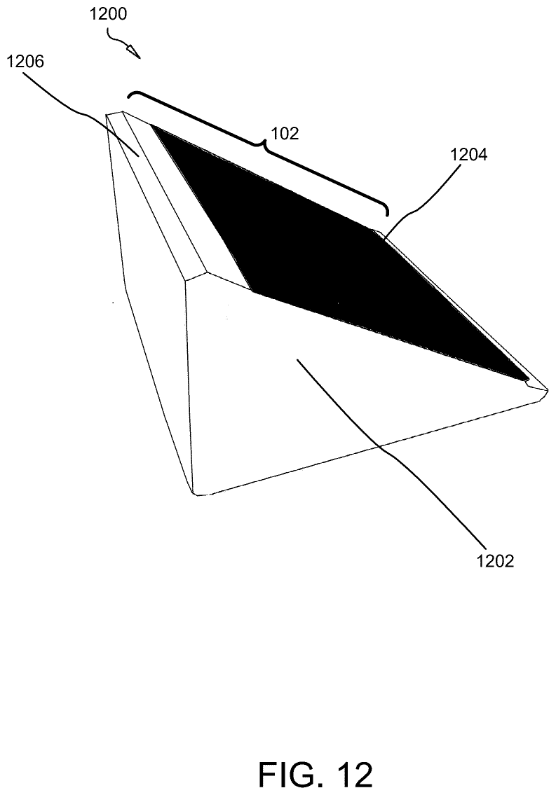

FIG. 12 is an environmental perspective view of a module of a modular, inclined positionable ramp for ambulatory animals 1200 in accordance with the present invention.

In various embodiments, the ramp comprises a simple wedge or right-angle triangle adapted to position between stairs. The ramp 1200 may have carpet or texture on the top 1204.

In various embodiments, the inclined top surface 1204 of the ramp module 1200 positions over a triangular body 1202.

The ramp module 1206 may having a planar top edge 1206.

In various embodiments, two ramps 600a-b may be joined using a slot 502 or aperture to form a freestanding apparatus 1100. In this embodiment, the ramp 1100 comprises four stringers including two pairs of stringers. Of these pairs of stringers, one pair may not include any modules 102 or include only one module 102. The ramp 1100 is operable to collapse for stowing and porting function. The two pairs of stringers 302 are hingedly connected.

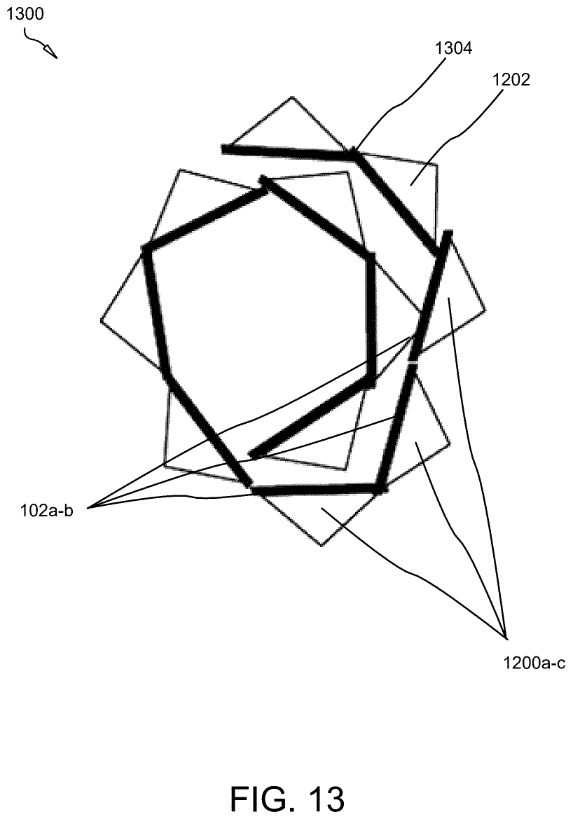

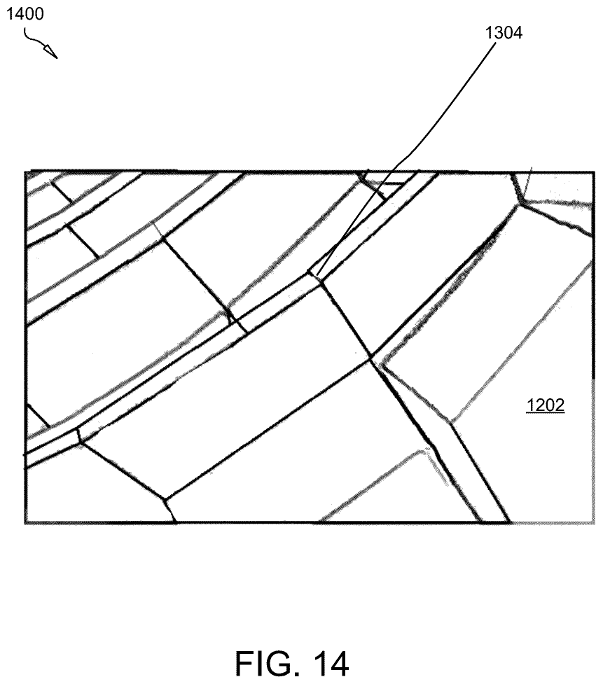

FIGS. 13-14 illustrate perspective views of a rolled, positionable ramp for ambulatory animals 1300, 1400 in accordance with the present invention.

In various embodiments, a plurality of ramp modules 1300 are conjoined along top and/or lower edges of the top surfaces 1204 of the ramp modules 1300. The modules 1300a-c may be hingedly connected. The ramp 1300 may be operable to roll up for storage. In a rolled configuration, the ramp 1300 is easier to position on stairs, either at the top or bottom, and may be unrolled into place.

The ramp modules 1300 may be connected at a junction point 1304. The ramp modules may be dimension to approximately the size of a standard-size stair. In some cases, the ramp modules overhang or underhand stairs, which may change the degree to which the top surface 1502 is inclined or declined.

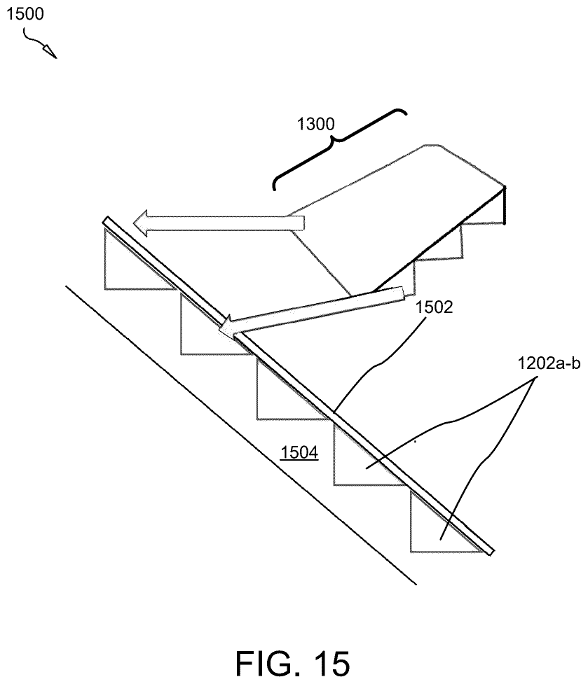

FIG. 15 is a side, environmental perspective view of a rolled, positionable ramp 1500 for ambulatory animals in accordance with the present invention.

The ramp 1500 is unrolled on top of a staircase 1504 such that the triangular bodies 1202 are each wedged, or positioned, above a stair of the staircase 1504.

In some embodiments, a single, flexible top 1502 covers all of the triangular boxes 1202a-b. This flexible top 1502 allows the triangular boxes 1202 to rotate, or roll, around a central axis.

In various embodiments, the flexible top 1502 comprises polymeric and/or woven fibers (such as carpet). The flexible top 1502 is sufficiently flexible to fold or roll and bend such that the ramp assemblage 1500 may collapse into a rolled (i.e., closed) configuration. In some embodiments, the flexible top 1502 is operable to stretch such that the ramp assemblage 1500 may accommodate stairs differing dimensions.

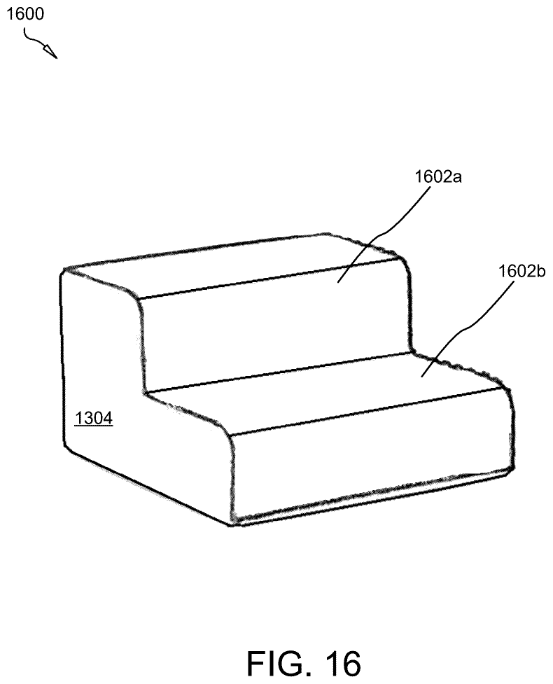

FIG. 16 is a perspective view of a ramp module for ambulatory animals 1600 in accordance with the present invention.

In various embodiments, the top surface of the ramp module 1600 is staggered to form two steps in place of the inclined top surface 1204, 1502. This allows animals 1702 which are smaller is size and/or stature, or disabled animals, to take smaller steps up when ascending or descending the stairs.

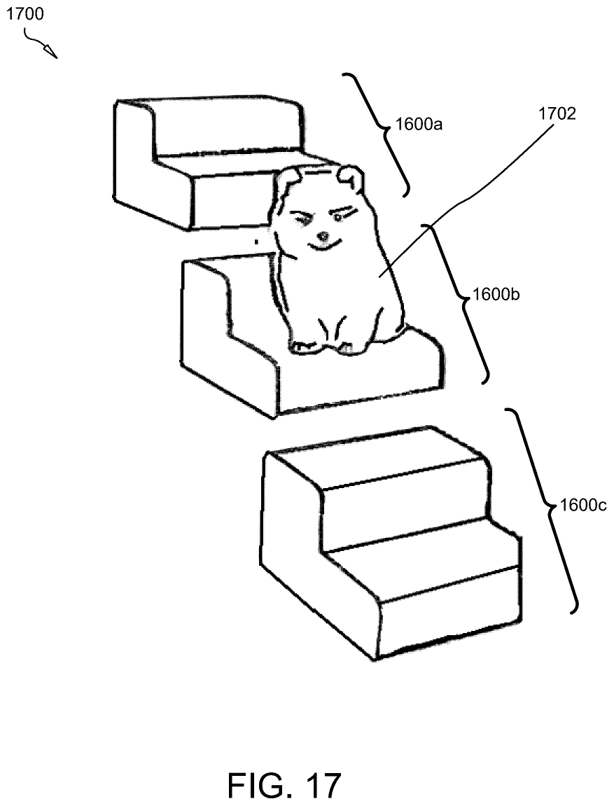

FIG. 17 is a perspective view of a positionable ramp module for ambulatory animals in accordance with the present invention.

A plurality of independent or hingedly affixed ramp modules 1600 may be positioned on a staircase 1504.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A modular positionable ramp assemblage comprising:
a plurality of ramp modules, each ramp module comprising:
a triangular body defining a hollow interior recess;
an inclined top surface affixed to a top surface of the ramp module;
wherein each ramp module is dimensioned to fit above, without cantileveing over, a standard-size stair of a staircase;
wherein each of the plurality of ramp modules are hingedly affixed to one or more adjacent ramp modules such that the ramp assemblage is operable to roll into a closed configuration.

2. The modular positionable ramp assemblage of claim 1, wherein each ramp module further comprises two triangular sidewalls, a hypotenuse of each sidewall detachably affixed to an inclined top surface.

3. The modular positionable ramp assemblage of claim 1, wherein the inclined top surface forms two or more stairs.

4. The modular positionable ramp assemblage of claim 1, wherein each ramp module further comprises one rectangular baseplate detachably affixed to the two triangular sidewalls.

5. The modular positionable ramp assemblage of claim 1, wherein each ramp module further comprises two triangular sidewalls, a hypotenuse of each sidewall detachably affixed to an inclined top surface.

6. The modular positionable ramp assemblage of claim 1, wherein the sidewalls define a plurality of apertures adapted to align with the slots.

7. The modular positionable ramp assemblage of claim 1, further comprising two stringers.

8. A modular positionable ramp assemblage comprising:
a plurality of ramp modules comprising a solid block of polymeric material shaped to include: a single rectangular platform having a planar top surface; two triangular sidewalls, an hypotenuse of each sidewall detachably affixed to the rectangular platform; a rectangular baseplate affixed to the two triangular sidewalls; a rectangular backplate detachably affixed to the two triangular sidewalls;
wherein each of the plurality of ramp modules are hingedly affixed to one or more adjacent ramp modules.

9. The modular positionable ramp assemblage of claim 8, wherein each ramp module further comprises a textured top surface.

10. The modular positionable ramp assemblage of claim 8, wherein the inclined top surface forms two or more stairs.

11. A modular positionable ramp assemblage comprising:
a plurality of ramp modules, each ramp module comprising:
a triangular body defining a hollow interior recess;
wherein each ramp module is dimensioned to fit above, without cantileveing over, a standard-size stair of a staircase;
a flexible, inclined top surface affixed across top surfaces of the ramp modules, the flexible inclined top surface bending at connection points between the ramp modules such that the ramp assemblage is operable to roll into a closed configuration.

12. The modular positionable ramp assemblage of claim 11, wherein each ramp module further comprises two triangular sidewalls, a hypotenuse of each sidewall detachably affixed to an inclined top surface.

13. The modular positionable ramp assemblage of claim 11, wherein the inclined top surface forms two or more stairs.

14. The modular positionable ramp assemblage of claim 11, wherein each ramp module further comprises one rectangular baseplate detachably affixed to the two triangular sidewalls.

15. The modular positionable ramp assemblage of claim 11, wherein each ramp module further comprises two triangular sidewalls, a hypotenuse of each sidewall detachably affixed to an inclined top surface.

16. The modular positionable ramp assemblage of claim 11, wherein the sidewalls define a plurality of apertures adapted to align with the slots.

17. The modular positionable ramp assemblage of claim 11, further comprising two stringers.
